(19) United States
(12) Patent Application Publication
(10) Pub. No.: US 2022/0244226 A1
(43) Pub. Date: Aug. 4, 2022

(54) Method and Apparatus for Identifying Volatile Substances Using Resonator-Amplified Raman Spectroscopy Under Reduced Pressure

(71) Applicant: Institut für Nanophotonik Goettingen e.V., Goettingen (DE)

(72) Inventors: Georgios Ctistis, Kassel (DE); Christoph Lenth, Goettingen (DE); Hainer Wackerbarth, Kassel (DE)

(21) Appl. No.: 17/433,029

(22) PCT Filed: Feb. 21, 2020
(86) PCT No.: PCT/EP2020/054635

§ 371 Date: Apr. 18, 2022

(30) Foreign Application Priority Data
Feb. 21, 2019 (DE) 10 2019 104 481.2

(51) Int. Cl. G01N 30/74; G01N 30/72; G01N 30/32; G01N 30/30

(52) U.S. Cl. CPC G01N 30/74; G01N 30/7206; G01N 2030/025; G01N 30/30; G01N 30/32

(57) ABSTRACT

In order to identify substances, the substances to be identified are guided in a gas phase through a gas cell (2). A partial pressure of the substances to be identified in the gas cell (2) is kept to be less than 5×10⁴ Pa. Light (9) is radiated into the gas cell (2). A spectral composition of light (7) scattered out of the gas cell (2) is analyzed. The gas cell (2) is arranged in a resonator (10) which is tuned to at least one wavelength of the light (9) radiated-in or of the scattered light (7).

### TECHNICAL FIELD OF THE INVENTION

The invention relates to a method of identifying substances. Particularly, the invention relates to a method comprising the steps of guiding the substances to be identified in a gas phase through a gas cell, and analyzing a spectral composition of light scattered out of the gas cell laterally with respect to the radiated light. Further, the invention relates to an apparatus for identifying substances and particularly to an apparatus comprising a gas cell which is configured for receiving the substances to be identified in a gas phase, a light source configured for radiating light into the gas cell, a spectrometer configured and arranged for analyzing a spectral composition of light scattered out of the gas cell, and a pump device for adjusting a pressure in the gas cell.

The present invention belongs to the field of gas analytics. The analysis of the spectral composition of the light scattered out of the gas cell may particularly be the detection of lines of Raman radiation scattered out of the gas cell, whose wavelengths are characteristic for the scattering substances.

### PRIOR ART

A method of and an apparatus for preparing an analysis of gas dissolved in a fluid and an analysis system for an analysis of this gas are known from WO 2017/125 214 A1. The apparatus for preparing the analysis includes a pump comprising a housing for conveying the fluid. In the interior of the housing, a sample space for degassing the fluid is formed, in order to extract the gas dissolved in the fluid in the sample space. The apparatus further includes a reactor to cause a physical interaction with the gas extracted. Particularly, the reactor is configured for causing a Raman-scattering of incident laser radiation depending on the gas extracted. The reactor includes an optical multi-pass-cell in which the laser radiation runs forth and back until it is scattered out of the reactor. In order to degas the fluid, the pump enlarges the space within the sample space such that a defined underpressure results. For evaluating the Raman-emission out of the reactor with regard to which components are included in the gas extracted out of the fluid, the spectrum of the scattered laser radiation may be compared to a number of reference spectra of known gases. After the analysis, the reactor and the sample space are evacuated towards a fluid outlet. For this purpose, at first a fluid connection between the surroundings of the apparatus and the reactor is provided, and then the entire content of the reactor is emptied into the sample space, before the content of the sample space is removed via the fluid outlet. In this procedure, there is the danger that the substances extracted out of the fluid accumulate at the walls of the reactor and are not removed in flushing the reactor with air out of the surroundings. Thus, they are diverted into subsequent measurements and falsify them.

US 2004/0 042 006 A1 discloses a multiplexing coherent Raman-spectrometer and a spectroscopic method of detecting and identifying individual components of a chemical composition which are separated into individual gases in a gas chromatograph. The gases are one after the other guided through a heated gas cell without windows into which light is radiated. Raman-radiation scattered by the gases out of the gas cell is filtered and supplied to a monochromator with multichannel detection. The light radiated into the gas cell is laser light which, in part, is passed through a further gas cell before. In this further gas cell, the laser light is scattered by a further gas of known composition which is under overpressure, in order to provide a broad bandwidth coherent beam with a bandwidth of more than 3,000 wavenumbers.

An optical measurement apparatus for online-measuring the gas content in a gas pipe is known from CN 106 053 428 A. The measurement apparatus comprises a Raman-radiation amplification device comprising a Fabry-Perot-resonator. For forming this Fabry-Perot-resonator, reflectors are arranged at two ends of a sample cell which further comprises a gas inlet and a gas outlet and a window for the Raman-radiation. Each of the reflectors comprises a spherical surface in whose center a circular plane area is arranged. In this way, a double Fabry-Perot-resonator is formed, each between the spherical surface of the one and the plane area of the other reflector. The Fabry-Perot-resonator amplifies laser light which is radiated through a window in one of the two reflectors. By means of the amplified laser light the Raman-radiation which is coupled out of the window at the side of the sample cell is amplified by several orders of magnitude.

A Raman spectrum amplification device comprising a piezo-electrically controlled resonator is known from CN 106 248 651 A. A laser diode, via a focusing device, and a spectrometer, via a light guiding device, are connected to a resonator. By piezo-electrically controlling the resonator, an up to 10,000-fold amplification of the Raman spectrum is achieved.

WO 2018/009 953 A1 discloses an apparatus for photothermal interferometry for detecting a molecule in a sample, particularly for detecting a trace gas. The apparatus comprises a Fabry-Pérot-interferometer having a cavity for receiving the sample between two mirrors. The cavity is part of a gas cell. Via one of the two mirrors, a measuring laser beam is coupled into the cavity between the mirrors, and the intensity of the light exiting the cavity again through the other mirror is measured with a photodetector. This intensity changes with variations of the refraction index of the sample between the mirrors, because the refraction index of the mirrors determines the optical length of the cavity and thus the tuning of the cavity to the wavelength of the measuring laser beam. The variation of the refraction index of the sample is dependent on how strongly the sample absorbs an excitation laser beam which is laterally radiated into the cavity of the Fabry-Pérot-interferometer. In the known apparatus, the wavelength of the excitation laser beam can be varied. In order to keep the absorption lines of the sample narrow with regard to the wavelength of the excitation laser beam, the pressure within the gas cell is reduced to 200 mbar.

US 2018/0 052 047 A1 discloses an apparatus for carbon isotope analysis comprising a gas cell within a tunable resonator between two resonator mirrors. A laser beam of variable wavelengths is coupled-in via the one of the resonator mirrors, and the intensity of the laser light exiting the resonator via the other resonator mirror again is monitored with a photodetector. A plurality of photodetectors for different frequency components of the coupled-in laser light may also be provided. Thus, the known apparatus comprises a Fabry-Perot-interferometer in which the transmission through the resonator, in addition to the tuning of the length of the resonator to the wavelength of the coupled-in laser light, is determined by the absorption of the coupled-in laser light by the gas in the gas cell. This absorption is amplified by the repeated running forth and back of the laser light in the resonator.

### Problem of the Invention

It is the problem of the invention to provide a method and an apparatus for identifying substances in which the danger of diverting the substances to be identified into subsequent measurements is minimized.

### Solution

The problem of the invention is solved by a method comprising the features of independent claim 1 and by an apparatus comprising the features of independent claim 12. In the dependent claims, preferred embodiments of the method according to the invention and the apparatus according to the invention are defined.

### DESCRIPTION OF THE INVENTION

In a method according to the invention of identifying substances in which the substances to be identified are guided through a gas cell in a gas phase, in which light is radiated into the gas cell, and in which a spectral composition of radiated light laterally scattered out of the gas cell is analyzed, a partial pressure of the substances to be analyzed in the gas cell is kept at less than 5×10⁴ Pa, and the gas cell is arranged in a resonator which is tuned to at least one wavelength of the radiated light or the scattered light. The spectrally analyzed scattered light is a part of the light radiated into the gas cell which is scattered out of the gas cell laterally with respect to the radiated light. The process on which the scattering of the radiated light is based in the spectrally analyzed scattered light may particularly be Raman scattering.

By means of the low partial pressure of the substance to be identified in the gas cell, which is in the range of less than 5×10⁴ Pa, the danger of diverting the substance inti the subsequent measurements is minimized, because, in this way, not only the absolute amount of the substances to be identified in the gas cell is kept small but also the tendency of the substances to be identified to condense at the walls of the gas cell is minimized, as the dew point of the substances to be identified decreases with their partial pressure. With the partial pressure of less than 5×10⁴ Pa, also substances which are only low-volatile can be securely kept in the gas phase and can thus easily be flushed out of the gas cell. However, the low partial pressure of the substances to be identified in the gas cell also has the result that the intensity of the light scattered by the substances to be identified, particularly the intensity of Raman scattering which is caused by the substances to be identified, is reduced. To nevertheless bring the intensity of the scattered light to a well detectable level, the gas cell, according to the invention, is arranged in a resonator which is tuned to a wavelength of the radiated light or the scattered light, such as to, via the intensity of the exciting light, indirectly or directly increase the intensity of the scattered light. Here, the tuning of the resonator may take place quickly to different wavelength of the radiated light and/or the scattered light one after the other. Going through the possible wavelength while analyzing the spectral composition of the light scattered out of the gas cell in parallel is also possible. By means of the arrangement of the gas cell in the resonator and the tuning of the resonator for amplifying the light scattered out of the gas cell, sufficient intensities of the scattered light with the wavelengths which are characteristic for the substances to be identified are obtained in the method according to the invention.

When the partial pressure of the substances to be identified in the gas cell is kept at less than 3×10⁴ Pa and particularly at a value between 2×10⁴ Pa and 0.2×10⁴ Pa, the danger of condensation of the substances to be identified at the walls of the gas cell and thus their diversion into subsequent measurements is also minimized, even if the substances to be identified are low-volatile and, accordingly, strongly tend to condensation.

It is preferred in the method according to the invention, if not only the partial pressure of the substances to be identified but also an absolute pressure in the gas cell is held at less than 5×10⁴ Pa, preferably at less than 3×10⁴ Pa and most preferably on a value between 2×10⁴ Pa and 0.2×10⁴ Pa. Ideally, only the substances to be identified are in the gas cell so that the light scattered out of the gas cell may only be assigned to the substances to be identified. If, besides the substances to be identified, a further gas is in the gas cell, for example a carrier gas in which the substances to be identified are guided through the gas cell, this is preferably an inert gas that does not react with the substances to be identified and that reflects the light radiated into the gas cell at other wavelengths than the substances to be identified such that an easy spectral separation of the light components from the carrier gas and the substances to be identified is possible. This particularly applies if the absolute pressure in the gas cell is by a multiple higher than the partial pressure of the substances to be identified in the gas cell.

If the radiated light is coupled in the resonator, i.e. the resonator is oriented in the direction of the radiated light, wherein the spectrally analyzed scattered light is laterally emitted out of the resonator, the radiated light then passes several times through the gas cell even if the resonator is not tuned to the wavelength of the radiated light but onto a wavelength of the scattered light so that, even then, the probability of an interaction of this radiated light with the substance to be identified is strongly increased in an advantageous way.

In the method according to the invention, the resonator is, preferably, automatically tuned to the wavelength of the radiated light, for which purpose the intensity of the radiated light in the resonator may be monitored and maximized. Alternatively, the resonator may, as already indicated, be tuned-through, in order to amplify the different wavelength components of the scattered light one after the other. In case of using a carrier gas, besides the wavelength of the radiated light, wavelengths, at which the carrier gas scatters as is known, may also be purposefully omitted in tuning the resonator to the scattered light.

As an additional measure in order to avoid a condensation of the substances to be identified at the walls of the gas cell and thus a diversion of the substances to be identified into subsequent measurements, a temperature of inner surfaces of the gas cell may be held at a value above room temperature of, for example, between 60° C. and 180° C. and, preferably, between 90° C. and 140° C. These moderately increased temperatures, as a rule, collide neither with tuning the resonator to a certain wavelength nor with holding the partial pressure of the substances to be identified or the absolute pressure in the gas cell at the value of less than 5×10⁴ Pa.

The identification of the respective substances in the gas cell by means of the spectrum of the light scattered by them may be simplified in that, at each particular point in time, only few substances and in an ideal case only one single substance is contained in the gas cell, if applicable, besides the carrier gas. In order to achieve this, the substances to be identified can be guided through a gas chromatograph into the gas cell, through which they pass, dissolved in a carrier gas, at different speeds and correspondingly get into the gas cell at different points in time.

As the method according to the invention is also suitable for low-volatile substances, the substances to be identified may at first be transferred into the gas phase by reducing the absolute pressure and/or increasing their temperature, within which they are then guided through the gas cell. If the substances to be identified are guided into the gas cell through a gas chromatograph, the substances to be identified can be transferred into the gas phase in the gas chromatograph and then guided through the gas cell by evacuating at the outlet of the gas cell and the resulting pressure difference.

Out of the gas cell, the substances to be identified may be transferred into a mass spectrometer to obtain further information on the substances to be identified besides the light scattered by them.

Then, at the latest, a sufficient information base is available to even analyze such substances unambiguously which have overlapping spectra of the light scattered by them.

In an apparatus according to the invention for identifying substances, the apparatus comprising a gas cell which is configured for receiving the substances to be identified in a gas phase, a light source which is configured and arranged for radiating light into the gas cell, a spectrometer which is configured and arranged for analyzing a spectral composition of light scattered out of the gas cell laterally with respect to the radiated light, and a pump device which is configured for adjusting a pressure in the gas cell, the pump device is configured and connected for holding a partial pressure of the substances to be identified in the gas cell of less than 5×10⁴ Pa, and a resonator, that is tunable to at least one wavelength of the radiated light or the scattered light, encloses the gas cell.

The spectrometer may particularly be a Raman-spectrometer, i.e. specially adapted to a spectral analysis of Raman scattered light. This means that the spectrometer is specially configured for resolving wavelengths of the scattered light which are Raman shifted with respect to the radiated light.

The light source may particularly be arranged to couple the radiate light into the resonator, the spectrometer then being arranged to analyze the spectral composition of the scattered light laterally emitted out of the resonator.

An additional tuning device of the apparatus according to the invention may be configured for automatically tuning the resonator to the wavelength of the scattered light or for tuning the resonator through with regard to the wavelength of the scattered light. The tuning device may particularly relocate or continuously or periodically shift a reflector delimiting the resonator dependently on a measured intensity of the radiated light in the resonator.

Additional heating devices of the apparatus according to the invention may be configured for holding a temperature of inner surfaces of the gas cell at a value between 60° C. and 180° C.

A gas reservoir and a gas guiding device of the apparatus may be configured and connected for guiding the substances to be identified through the gas cell in a carrier gas.

Gas-upstream, a gas chromatograph of the apparatus may be connected to the gas cell, and this gas chromatograph may comprise at least one capillary tube through which the substances to be identified are guided in the carrier gas. Practically, the gas chromatograph may comprise a thermal evaporator which brings the substances into the gas phase and which is under an overpressure. This overpressure may not only be present with respect to the gas cell but also absolutely, i.e. with respect to normal pressure. By means of the pressure difference resulting from the overpressure, the gas phase enters into a chromatographic column of the gas chromatograph which may also be heated to avoid condensation. After the column, the gas may enter into a heated capillary tube which is connected to the gas cell and serves as a transfer capillary. The gas cell is evacuated and also heated. In this way, it is ensured that no condensation occurs within the gas cell and that the volumes of the substances emitted out of the chromatographic column of the gas chromatograph are sufficient to identify them.

An evaporation device, if applicable as a part of the gas chromatograph, may be arranged for transferring the substances to be identified into the gas phase by reducing the ambient pressure and/or increasing their temperature.

Gas-downstream, a mass spectrometer of the apparatus may be connected to the gas cell. Insofar as a carrier gas is used, it is to be understood that this carrier gas should provide a signal which is as far as possible separable from the substances to be identified both in the mass spectrometer and in the spectrometer for analyzing the spectral composition of the light scattered out of the gas cell.

Advantageous developments of the invention result from the claims, the description and the drawings. The advantages of features and of combinations of a plurality of features mentioned at the beginning of the description only serve as examples and may be used alternatively or cumulatively without the necessity of embodiments according to the invention having to obtain these advantages. Without changing the scope of protection as defined by the enclosed claims, the following applies with respect to the disclosure of the original application and the patent: further features may be taken from the drawings, in particular from the illustrated designs and the dimensions of a plurality of components with respect to one another as well as from their relative arrangement and their operative connection. The combination of features of different embodiments of the invention or of features of different claims independent of the chosen references of the claims is also possible, and it is motivated herewith. This also relates to features which are illustrated in separate drawings, or which are mentioned when describing them. These features may also be combined with features of different claims. Furthermore, it is possible that further embodiments of the invention do not have the features mentioned in the claims.

The number of the features mentioned in the claims and in the description is to be understood to cover this exact number and a greater number than the mentioned number without having to explicitly use the adverb “at least”. For example, if a resonator is mentioned, this is to be understood such that there is exactly one resonator or there are two resonators or more resonators. Additional features may be added to these features, or these features may be the only features of the respective method or the respective apparatus.

The reference signs contained in the claims are not limiting the extent of the matter protected by the claims. Their sole function is to make the claims easier to understand.

### BRIEF DESCRIPTION OF THE DRAWINGS

In the following, the invention is further explained and described with reference to preferred embodiment examples depicted in the drawings.

FIG. 1 shows an apparatus according to the invention for carrying out the method according to the invention in a first embodiment, and

FIG. 2 shows a pump device, gas guiding devices and further components of a further embodiment of the apparatus according to the invention.

### DESCRIPTION OF THE DRAWINGS

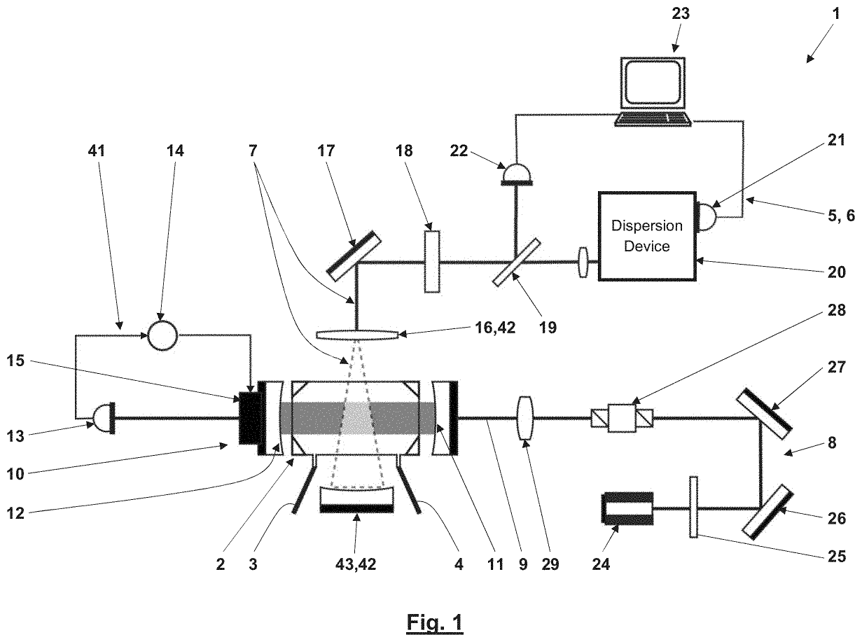

The apparatus 1 for identifying substances depicted in FIG. 1 comprises a gas cell 2 as a central element, which is configured for receiving the substances to be identified in a gas phase. For this purpose, the gas cell 2 comprises a gas inlet 3 and a gas outlet 4. A spectrometer 5, which is particularly made as a Raman-spectrometer 6, serves for analyzing a spectral composition of light 7 scattered out of the gas cell 2, i.e. particularly of so called Raman-radiation. The scattered light 7 is generated by means of a light source 8 which radiates light 9 into the gas cell 2. In order to be able to identify substances to be identified in the gas cell 2 due to the light 7 scattered by then even if a partial pressure of the substances in the gas cell 2 is only small, the gas cell 2 is arranged in a resonator 10. The resonator 10 is arranged between a coupling-in mirror 11, via which the light 9 from the light source 8 is coupled-in, and a coupling-out mirror 12, here. By means of a tuning device 41, the resonator 10 is tunable. For this purpose, a light sensor 13 of the tuning device 41 is arranged behind the coupling-out mirror 12, and depending on a signal of the light sensor 13, a piezo element 15, by which the coupling-out mirror 12 is shiftable in direction of its distance to the coupling-in mirror 11, is controlled by a controller 14. Practically, the resonator 10 may be tuned such that the intensity of the light 9 in the resonator 10 is maximized. In this way, the intensity of the light 7 scattered out of the gas cell 2 is also maximized.

The spectrometer 5 for monitoring and spectral analysis of the scattered light 7 includes a collecting optic 42 with a hollow mirror 43 and a collector lens 16, a deviation mirror 17 and a polarization unit 18 in order to measure the light 7 independently of its polarization, a notch filter 19 to stop components of the light 7 with the wavelength of the radiated light 9, a dispersion unit 20 to deviate the light 7 dependently on its wavelength, and a CCD-camera 21 to register the light 7 dependently on its wavelength. Light stopped by the notch filter 19 is detected with a light sensor 22 which, like the CCD-camera 21, is connected to the evaluation device 23.

The light source 8 comprises a laser 24, a laser line filter 25, deviation mirrors 26 and 27 and an optical diode 28. Between the light source 8 and the resonator 10 enclosing the gas cell 2, a focusing optic 29 is arranged.

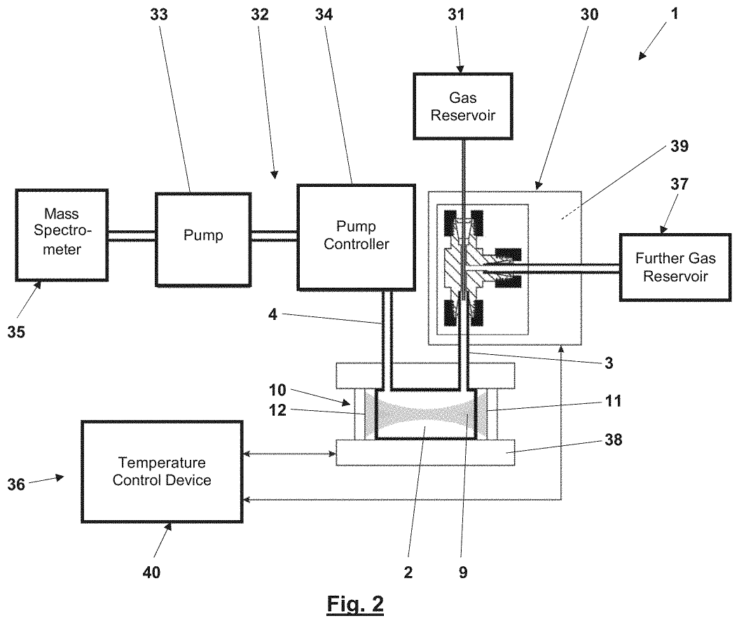

FIG. 2 shows how the gas cell 2 between the resonator mirrors 11 and 12 of the resonator 10, via its gas inlet 3, is connected to a gas chromatograph 30. Out of a gas reservoir 31, the substances to be analyzed are supplied to the gas chromatograph 30 in a carrier gas. Here, over the gas cell 2, the carrier gas and the substances to be identified are drawn in by a pump device 32 comprising a pump 33 and a pressure controller 34. By means of dividing the substances to be identified with the aid of the gas chromatograph 30, these substances to be identified enter into the gas cell one after the other, and they are one after the other analyzed by means of the light 7 scattered by them according to FIG. 1. Because the substances individually enter into the gas cell 2, their analysis is also possible at a low partial pressure of the respective substance, i.e. at a low concentration of the respective substance to be identified and a corresponding low intensity of the light 7 scattered by it, especially as the intensity of the scattered light 7 is maximized by the high intensity of the light 9 radiated into the gas cell. Further, the substances to be identified can be transferred by the pump 33 into a mass spectrometer 35 that provides further information on the substances to be identified.

A contamination of the apparatus 1 by previously identified substances, particularly if they are low-volatile, is, besides the low partial pressure of the substances, effected by means of a heating device 36 and by flushing the gas chromatograph 30 and the gas cell 2 with a flushing gas out of a further gas reservoir 37. The heating device includes heating elements 38 for the inner surfaces of the gas cell 2 and further heating devices 39 for the gas chromatograph 39 and a temperature controller 40 which adjusts a temperature in a range between 60° C. and 180° C. Also with these moderate temperatures, a condensation even of low-volatile substances and thus a diversion of these substances into subsequent measurements can be avoided in the apparatus 1 due to the low partial pressure according to the invention.

### LIST OF REFERENCE NUMERALS

1 apparatus
2 gas cell
3 gas inlet
4 gas outlet
5 spectrometer
6 Raman-spectrometer
7 scattered light
8 light source
9 radiated light
10 resonator
11 coupling-in mirror
12 coupling-out mirror
13 light sensor
14 controller
15 piezoelectric element
16 collector lens
17 deviation mirror
18 polarization unit
19 notch filter
20 dispersion device
21 CCD-camera
22 light sensor
23 evaluation device
24 laser
25 laser filter
26 deviation mirror
27 deviation mirror
28 optical diode
29 focusing optic
30 gas chromatograph
31 gas reservoir
32 pump device
33 pump
34 pump controller
35 mass spectrometer
36 temperature control device
37 further gas reservoir
38 heating element
39 heating element
40 temperature controller
41 tuning device
42 collecting optic
43 hollow mirror

1. A method of identifying substances comprising the steps of
guiding the substances to be identified in a gas phase through a gas chromatograph into and through a gas cell arranged between two mirrors,
keeping a partial pressure of the substances to be identified in the gas cell to be less than 5×10⁴ Pa,
radiating light into the gas cell, and
analyzing a spectral composition of light, that is, by means of Raman-scattering, scattered out of the gas cell laterally with respect to the radiated light.

2. (canceled)

3. The method of claim 1, wherein the partial pressure of the substance to be identified in the gas cell is kept to be less than 3×10⁴ Pa.

4. The method of claim 1, wherein an absolute pressure in the gas cell is kept to be at least one of less than 5×10⁴ Pa or less than 3×10⁴ Pa.

5. The method of claim 1, wherein a resonator is formed with the two mirrors, wherein the radiated light is coupled into the resonator through one of the two mirrors, and wherein the spectrally analyzed scattered light is laterally emitted out of the resonator.

6. The method of claim 1, wherein a resonator is formed with the two mirrors, and wherein the resonator is automatically tuned to a wavelength of the radiated light or tuned-through with respect to wavelengths of the scattered light.

7. The method of claim 1, wherein a temperature of inner surfaces of the gas cell is held at a value between 80° C. and 140° C.

8. The method of claim 1, wherein the substances to be identified are guided through the gas cell within a carrier gas.

9. (canceled)

10. The method of claim 1, wherein the substances to be identified are transferred into the gas phase by at least one of reducing the absolute pressure on their surroundings and increasing their temperature.

11. The method of claim 1, that the substances to be identified are transferred out of the gas cell into a mass spectrometer.

12. An apparatus for identifying substances, the apparatus comprising
a gas chromatograph,
a gas cell connected gas-downstream to the gas chromatograph, configured for receiving the substances to be identified in a gas phase from the gas chromatograph, and arranged between two mirrors,
a light source configured and arranged for radiating light into the gas cell,
a Raman-spectrometer configured and arranged for analyzing a spectral composition of light scattered out of the gas cell laterally with respect to the radiated light, and
a pump device for adjusting a pressure in the gas cell,
wherein the pump device is configured and connecting for keeping a partial pressure of the substances to be identified in the gas cell at less than 5×10⁴ Pa.

13. (canceled)

14. The apparatus of claim 12, comprising a resonator formed by the two mirrors, wherein the light source is arranged to couple the radiated light into the resonator through one of the two mirrors, and that the Raman-spectrometer is arranged to analyze the spectral composition of the scattered light laterally emitted out of the resonator.

15. The apparatus of claim 12, comprising a resonator formed by the two mirrors and a tuning device configured and arranged for automatically tuning the resonator to a wavelength of the radiated light or for tuning-through the resonator with respect to wavelengths of the scattered light.

16. The apparatus of claim 12, comprising heating devices configured and arranged for holding a temperature of inner surfaces of the gas cell at a value between 60° C. and 180° C.

17. The apparatus of claim 12, comprising a gas reservoir and gas guiding devices configured and connected for guiding the substances to be identified in a carrier gas through the gas cell.

18. (canceled)

19. The apparatus of claim 12, wherein the gas chromatograph comprises at least one capillary tube.

20. The apparatus of claim 12, comprising an evaporator device configured for transferring the substances to be identified into the gas phase by at least one of reducing the absolute pressure in their surroundings and increasing their temperature.

21. The apparatus of claim 12, comprising a mass spectrometer gas-downstream connected to the gas cell.

22. The method of claim 1, characterized in that the partial pressure of the substance to be identified in the gas cell is kept at a value between 2×10⁴ Pa and 0.2×10⁴ Pa.

23. The method of claim 1, wherein the absolute pressure in the gas cell is kept to be at a value between 2×10⁴ Pa and 0.2×10⁴ Pa.
